(19) United States
(12) Patent Application Publication
(10) Pub. No.: US 2016/0044641 A1
(43) Pub. Date: Feb. 11, 2016

(54) HANDLING DOWNLINK SEMI-PERSISTENT SCHEDULING RETRANSMISSION IN WIRELESS NETWORKS

(71) Applicants: Wei BAI, (US); Haiming WANG, (US)

(72) Inventors: Wei BAI, Beijing (CN); Haiming WANG, Beijing (CN)

(73) Assignee: BROADCOM CORPORATION, Irvine, CA (US)

(21) Appl. No.: 14/782,095

(22) PCT Filed: Apr. 3, 2013
(86) PCT No.: PCT/CN2013/073710

§ 371 Date: Oct. 2, 2015

(51) Int. Cl. H04W 72/04; H04W 76/04; H04L 5/00; H04L 5/14

(52) U.S. Cl. CPC H04W 72/042; H04L 5/14; H04W 76/048; H04L 5/0053

(57) ABSTRACT

During discontinue reception (DRX) operation of a mobile terminal of a wireless communications network, methods to ensure that user equipment is in an awake mode when a network node sends a scheduling grant on the physical downlink control channel (PDCCH). Dynamic scheduling (DS) and semi-persistent scheduling (SPS) grants may appear on PDCCH only once. One method defines every received downlink (DL) semi-persistent scheduling (SPS) signal in a subframe as active time in a configured DRX cycle and includes in said defining active time any occurrence of a DL assignment being configured for the subframe. A second method receives an indication of a downlink transmission or a configured downlink assignment configured for the current PDCCH subframe, starts a Hybrid Automatic Repeat request (HARQ) Round Trip Timer (RTT) whether UE is in active time or not, and stops a drx-RetransmissionTimer for the corresponding HARQ process whether UE is in active time or not.

### TECHNOLOGICAL FIELD

This described embodiment(s) is related to wireless network communications technology, particularly to the Long Term Evolution (LTE) Medium Access Control (MAC) procedures. More specifically, it is related to Discontinue Reception (DRX) operation and potential downlink (DL) semi-persistent scheduling (SPS) retransmission.

### BACKGROUND

As specified for LTE MAC, DRX operation is controlled by several timers, such as onDurationTimer, drx-inactivityTimer, drx-retransmissionTimer, HARQ RTT timer (Hybrid Automatic Repeat Request Round Trip Timer), etc. For DRX operation, user equipment (UE) monitors the Physical Downlink Control Channel (PDCCH) for uplink (UL) grant and DL assignment when UE is in active time. The active time is defined as follows in the network specification:

When a DRX cycle is configured, the Active Time includes the time while:
onDurationTimer or drx-InactivityTimer or drx-RetransmissionTimer or mac-ContentionResolutionTimer (as described in subclause 5.1.5) is running; or
a Scheduling Request is sent on PUCCH and is pending (as described in subclause 5.4.4); or
an uplink grant for a pending HARQ retransmission can occur and there is data in the corresponding HARQ buffer; or
a PDCCH indicating a new transmission addressed to the C-RNTI of the UE has not been received after successful reception of a Random Access Response for the preamble not selected by the UE (as described in subclause 5.1.4).
   If drx-retransmissionTimer is running, UE should be in active time and needs to monitor PDCCH for scheduling. The purpose of this timer is to let UE monitor the potential DL retransmission within a time window because LTE use a-synchronized HARQ for DL transmission.

Another related timer is onDurationTimer. This timer runs periodically with a fixed pattern. As defined in the network specification:
If the Short DRX Cycle is used and [(SFN*10)+subframe number] modulo (shortDRX-Cycle)=(drxStartOffset) modulo (shortDRX-Cycle); or
if the Long DRX Cycle is used and [(SFN*10)+subframe number] modulo (longDRX-Cycle)=drxStartOffset:
start onDurationTimer.

There are two kinds of scheduling mechanism in the LTE system, dynamic scheduling (DS) and semi-persistent scheduling (SPS). For dynamic scheduling, a serving node (evolved Node B (eNB)) will send PDCCH every time it wants to schedule the UE. For SPS, eNB could send the PDCCH only once and this scheduling grant will be effective periodically so eNB doesn't need to send PDCCH on every occasion.

A problem with the current MAC specification has been noted, which the embodiments described herein are designed to correct. For the DRX operation, described in the above section, UE will only monitor PDCCH for scheduling grant/assignment when it is in active time. Therefore, to make UE awake at the right time is the most important thing for DRX.

As presently specified in the LTE MAC specification,
during the Active Time, for a PDCCH-subframe, if the subframe is not required for uplink transmission for half-duplex FDD UE operation and if the subframe is not part of a configured measurement gap:
   monitor the PDCCH;
   if the PDCCH indicates a DL transmission or if a DL assignment has been configured for this subframe:
      start the HARQ RTT Timer for the corresponding HARQ process;
      stop the drx-RetransmissionTimer for the corresponding HARQ process.
   if the PDCCH indicates a new transmission (DL or UL):
      start or restart drx-InactivityTimer.
         That means that HARQ RTT timer will be only started when UE is in active time. There is no problem for dynamic scheduling because each dynamic scheduling requires one PDCCH and UE will monitor PDCCH only in active time. However, the description in the MAC specification also includes the SPS case: “a DL assignment has been configured for this subframe.” So there could be also the case that DL SPS happens outside the active time. Thus, HARQ RTT timer would not start in this case.

HARQ RTT timer also controls the start of drx-retransmissionTimer according to the MAC spec:

When DRX is configured, the UE shall for each subframe:
if a HARQ RTT Timer expires in this subframe and the data of the corresponding HARQ process was not successfully decoded:
start the drx-RetransmissionTimer for the corresponding HARQ process.
   As described in the above section, drx-retransmissionTimer is used to enable UE to monitor a potential DL retransmission. However, because UE will not start HARQ RTT timer if there is DL SPS new transmission when UE is not in active time, the drx-retransmissionTimer for the corresponding DL SPS transmission will never be started because HARQ RTT timer will not expire. Therefore, UE will enter sleep and will not receive the potential DL retransmission for DL SPS. Also, according to the spec, the drx-retransmissionTimer for the previous packet will not be stopped so UE will have to monitor additional subframes, which consumes more power.

### BRIEF SUMMARY

A first method is described comprising defining every subframe where downlink (DL) semi-persistent scheduling (SPS) signal could be received as active time in a configured Discontinue Reception (DRX) cycle; and including in said defining active time any occurrence of a DL assignment being configured for the subframe. Also included in defined active time is a period of running at least one timer, the timer being one of an onDurationTimer or drx-InactivityTimer or drx-RetransmissionTimer or mac-ContentionResolutionTimer. The method also comprises including in defined active time a period when an uplink grant is pending after a Hybrid Automatic Repeat request (HARQ) when there is data in a corresponding HARQ buffer, and including in defined active time a period of pending time after a Scheduling Request is caused to be sent on Physical Uplink Control Channel (PUCCH). Active time further includes a time period during which a Physical Downlink Control Channel signal addressed to the Cell Radio Network Temporary Identity (CRNTI) has not been received after successful reception of a Random Access Response (RAR) for an RAR preamble not selected.

A second method comprises receiving an indication of a downlink transmission or a downlink assignment configured for the current PDCCH subframe, starting a Hybrid Automatic Repeat request (HARQ) Round Trip Timer (RTT), and stopping a drx-RetransmissionTimer for the corresponding HARQ process. This method further comprises monitoring a Physical Downlink Control Channel (PDCCH) subframe when during active time the PDCCH subframe is not required for uplink transmission for half-duplex frequency division duplex (FFD) operation and is not part of a configured measurement gap, receiving an indication of a new transmission, whether uplink or downlink; and starting or restarting drx-InactivityTimer.

In another embodiment, an apparatus comprises at least a processor, a memory in communication with said processor and having computer coded instructions stored therein, said instructions when executed by the processor being configured to cause the apparatus to perform: defining every subframe where downlink (DL) semi-persistent scheduling (SPS) signal could be received as active time in a configured Discontinue Reception (DRX) cycle; and including in said defining active time any occurrence of a DL assignment being configured for the subframe. Further instructions are configured to include in defined active time a period of running at least one timer, said timer being one of an onDurationTimer or drx-InactivityTimer or drx-RetransmissionTimer or mac-ContentionResolutionTimer, including a period when an uplink grant is pending after a Hybrid Automatic Repeat request (HARQ) when there is data in a corresponding HARQ buffer. The apparatus may further comprise instructions causing the apparatus to perform including in defined active time a period of pending time after a Scheduling Request is caused to be sent on Physical Uplink Control Channel (PUCCH), and including in defined active time a time period during which a Physical Downlink Control Channel signal addressed to the Cell Radio Network Temporary Identity (CRNTI) has not been received after successful reception of a Random Access Response (RAR) for an RAR preamble not selected.

Another apparatus embodiment comprises at least a processor, a memory in communication with said processor and having computer coded instructions stored therein, said instructions when executed by the processor configured to cause the apparatus to perform: receiving an indication of a downlink transmission or a downlink assignment configured for the current PDCCH subframe, starting a Hybrid Automatic Repeat request (HARQ) Round Trip Timer (RTT), and stopping a drx-RetransmissionTimer for the corresponding HARQ process. Further instructions may be configured to cause the apparatus to perform monitoring a Physical Downlink Control Channel (PDCCH) subframe when during active time the PDCCH subframe is not required for uplink transmission for half-duplex frequency division duplex (FFD) operation and is not part of a configured measurement gap, receiving an indication of a new transmission, whether uplink or downlink, and starting or restarting drx-InactivityTimer.

In alternative embodiment is a computer program product comprising a computer readable storage medium having computer coded instructions stored therein, said instructions when executed by the processor being configured to cause the apparatus to perform: defining every subframe where downlink (DL) semi-persistent scheduling (SPS) signal could be received as active time in a configured Discontinue Reception (DRX) cycle; and including in said defining active time any occurrence of a DL assignment being configured for the subframe. Further instructions are configured to include in defined active time a period of running at least one timer, said timer being one of an onDurationTimer or drx-InactivityTimer or drx-RetransmissionTimer or mac-ContentionResolutionTimer, including a period when an uplink grant is pending after a Hybrid Automatic Repeat request (HARQ) when there is data in a corresponding HARQ buffer. The apparatus may further comprise instructions causing the apparatus to perform including in defined active time a period of pending time after a Scheduling Request is caused to be sent on Physical Uplink Control Channel (PUCCH), and including in defined active time a time period during which a Physical Downlink Control Channel signal addressed to the Cell Radio Network Temporary Identity (CRNTI) has not been received after successful reception of a Random Access Response (RAR) for an RAR preamble not selected.

Another computer program product embodiment comprises a computer readable storage medium having computer coded instructions stored therein, said instructions when executed by the processor being configured to cause the apparatus to perform: receiving an indication of a downlink transmission or a downlink assignment configured for the current PDCCH subframe, starting a Hybrid Automatic Repeat request (HARQ) Round Trip Timer (RTT), and stopping a drx-RetransmissionTimer for the corresponding HARQ process. The computer program product may comprise further instructions configured to cause the apparatus to perform monitoring a Physical Downlink Control Channel (PDCCH) subframe when during active time the PDCCH subframe is not required for uplink transmission for half-duplex frequency division duplex (FFD) operation and is not part of a configured measurement gap, receiving an indication of a new transmission, whether uplink or downlink, and starting or restarting drx-InactivityTimer.

In another alternative embodiment is an apparatus comprising means for defining every subframe where downlink (DL) semi-persistent scheduling (SPS) signal could be received as active time in a configured Discontinue Reception (DRX) cycle, and means for including in said defining active time any occurrence of a DL assignment being configured for the subframe. This apparatus further comprises means for including in defined active time a period of running at least one timer, said timer being one of an onDurationTimer or drx-InactivityTimer or drx-RetransmissionTimer or mac-ContentionResolutionTimer, and means for including in defined active time a period when an uplink grant is pending after a Hybrid Automatic Repeat request (HARQ) when there is data in a corresponding HARQ buffer. The apparatus may also comprise means for including in defined active time a period of pending time after a Scheduling Request is caused to be sent on Physical Uplink Control Channel (PUCCH), and means for including in defined active time a time period during which a Physical Downlink Control Channel signal addressed to the Cell Radio Network Temporary Identity (CRNTI) has not been received after successful reception of a Random Access Response (RAR) for an RAR preamble not selected.

Another apparatus embodiment may comprise means for receiving an indication of a downlink transmission or a downlink assignment configured for the current PDCCH subframe, means for starting a Hybrid Automatic Repeat request (HARQ) Round Trip Timer (RTT); and means for stopping a drx-RetransmissionTimer for the corresponding HARQ process. The apparatus may further comprise means for monitoring a Physical Downlink Control Channel (PDCCH) subframe when during active time the PDCCH subframe is not required for uplink transmission for half-duplex frequency division duplex (FFD) operation and is not part of a configured measurement gap, means for receiving an indication of a new transmission, whether uplink or downlink, and means for starting or restarting drx-InactivityTimer.

### BRIEF DESCRIPTION OF THE SEVERAL VIEWS OF THE DRAWING(S)

Having thus described certain embodiments of the invention in general terms, reference will now be made to the accompanying drawings, which are not necessarily drawn to scale, and wherein:

FIG. 1 is a schematic diagram of the representative basic components of a wireless communication system.

FIG. 2 is a block diagram of a mobile terminal of a wireless communication system.

FIG. 3 is a flow diagram of a first method embodiment for defining Active Time.

FIG. 4 is a flow diagram of an alternative method embodiment.

### DETAILED DESCRIPTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As used in this application, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or application specific integrated circuit for a mobile phone or a similar integrated circuit in server, a cellular network device, or other network device.

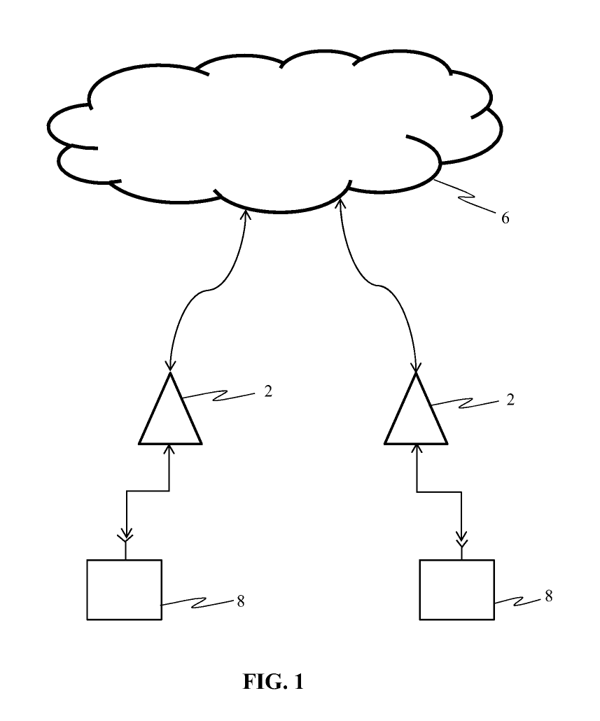

Although the method, apparatus and computer program product of example embodiments of the present invention may be implemented in a variety of different systems, one example of such a system is shown in FIG. 1, which includes a mobile terminal 8 that is capable of communication with a network 6 (e.g., a core network) via, for example, an access point 2 (AP). While the network may be configured in accordance with Global System for Mobile communications (GSM)/Enhanced Data rates for Global Evolution (EDGE) Radio Access Network (GERAN), the network may employ other mobile access mechanisms such as a Universal Mobile Telecommunications System (UMTS) Terrestrial Radio Access Network (UTRAN), Long Term Evolution (LTE), LTE-Advanced (LTE-A), wideband code division multiple access (W-CDMA), CDMA2000, and/or the like. The embodiments of the present invention may also be implemented in future LTE based technologies, such as LTE-A and subsequently developed mobile networks.

The network 6 may include a collection of various different nodes, devices or functions that may be in communication with each other via corresponding wired and/or wireless interfaces. For example, the network may include one or more base stations, such as one or more Base Transceiver Stations (BTSs) and Base Station Controllers (BSCs), node Bs, evolved node Bs (eNBs), access points (AP), relay nodes or the like (all of which being hereinafter generically referenced as an access point (AP)), each of which may serve a coverage area divided into one or more cells. For example, the network may include one or more cells, including, for example, the AP 2, each of which may serve a respective coverage area. The serving cell could be, for example, part of one or more cellular or mobile networks or public land mobile networks (PLMNs). In turn, other devices such as processing devices (e.g., personal computers, server computers or the like) may be coupled to the mobile terminal and/or the second communication device via the network.

The mobile terminals 8 may be in communication with each other or other devices via the network 6. In some cases, each of the mobile terminals may include an antenna or antennas for transmitting signals to and for receiving signals from a base station. In some example embodiments, the mobile terminal 8, also known as a client device, may be a mobile communication device such as, for example, a mobile telephone, portable digital assistant (PDA), pager, laptop computer, tablet computer, or any of numerous other hand held or portable communication devices, computation devices, content generation devices, content consumption devices, universal serial bus (USB) dongles, data cards or combinations thereof. As such, the mobile terminal 8 may include one or more processors that may define processing circuitry either alone or in combination with one or more memories. The processing circuitry may utilize instructions stored in the memory to cause the mobile terminal to operate in a particular way or execute specific functionality when the instructions are executed by the one or more processors. The mobile terminal 8 may also include communication circuitry and corresponding hardware/software to enable communication with other devices and/or the network 6.

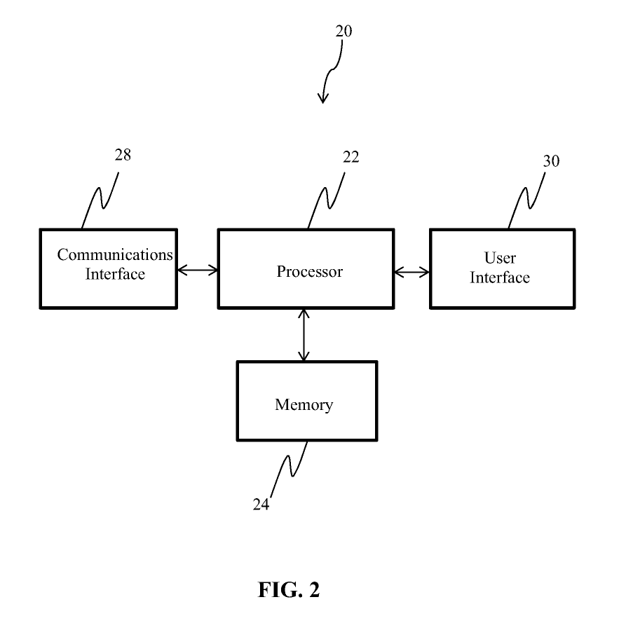

Referring now to FIG. 2, an apparatus 20 that may be embodied by or otherwise associated with a mobile terminal 8 (user equipment (UE), such as a cellular phone, a personal digital assistant (PDA), smartphone, tablet computer or the like) or an AP 2 may include or otherwise be in communication with a processor 22, a memory device 24, a communication interface 28, and a user interface 30.

In some example embodiments, the processor 22 (and/or co-processors or any other processing circuitry assisting or otherwise associated with the processor) may be in communication with the memory device 24 via a bus for passing information among components of the apparatus 20. The memory device 24 may include, for example, one or more non-transitory volatile and/or non-volatile memories. In other words, for example, the memory device 24 may be an electronic storage device (e.g., a computer readable storage medium) comprising gates configured to store data (e.g., bits) that may be retrievable by a machine (e.g., a computing device like the processor). The memory device 24 may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device 24 could be configured to store instructions for execution by the processor 22.

As noted above, the apparatus 20 may, in some embodiments, be embodied by a mobile terminal 8 or an AP 2. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 22 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading. In the embodiment in which the apparatus 20 is embodied as a mobile terminal 8, the processor may be embodied by the processor of the mobile terminal.

In an example embodiment, the processor 22 may be configured to execute instructions stored in the memory device 24 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a mobile terminal 8) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

Meanwhile, the communication interface 28 may be any means such as a device or circuitry embodied in either hardware or a combination of hardware and software that is configured to receive and/or transmit data from/to a network and/or any other device or module in communication with the apparatus 20. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In order to support multiple active connections simultaneously, such as in conjunction with a digital super directional array (DSDA) device, the communications interface of one embodiment may include a plurality of cellular radios, such as a plurality of radio front ends and a plurality of base band chains. In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

In some example embodiments, such as instances in which the apparatus 20 is embodied by a mobile terminal 8, the apparatus may include a user interface 30 that may, in turn, be in communication with the processor 22 to receive an indication of a user input and/or to cause provision of an audible, visual, mechanical or other output to the user. As such, the user interface may include, for example, a keyboard, a mouse, a joystick, a display, a touch screen(s), touch areas, soft keys, a microphone, a speaker, or other input/output mechanisms. Alternatively or additionally, the processor may comprise user interface circuitry configured to control at least some functions of one or more user interface elements such as, for example, a speaker, ringer, microphone, display, and/or the like. The processor and/or user interface circuitry comprising the processor may be configured to control one or more functions of one or more user interface elements through computer program instructions (e.g., software and/or firmware) stored on a memory accessible to the processor (e.g., memory device and/or the like).

A first potential solution to the identified problem with the present process defined in the MAC specification requires that UE should count every DL SPS new transmission occasion as active time. Adoption of this solution would result in alteration of the specified requirements into the following form.

When a DRX cycle is configured, the Active Time includes the time in which:
onDurationTimer or drx-InactivityTimer or drx-RetransmissionTimer or mac-ContentionResolutionTimer (as described in subclause 5.1.5) is running; or
a Scheduling Request is sent on PUCCH and is pending (as described in subclause 5.4.4); or
an uplink grant for a pending HARQ retransmission can occur and there is data in the corresponding HARQ buffer; or
a PDCCH indicating a new transmission addressed to the C-RNTI of the UE has not been received after successful reception of a Random Access Response for the preamble not selected by the UE (as described in subclause 5.1.4), or:
a DL assignment has been configured for this subframe.

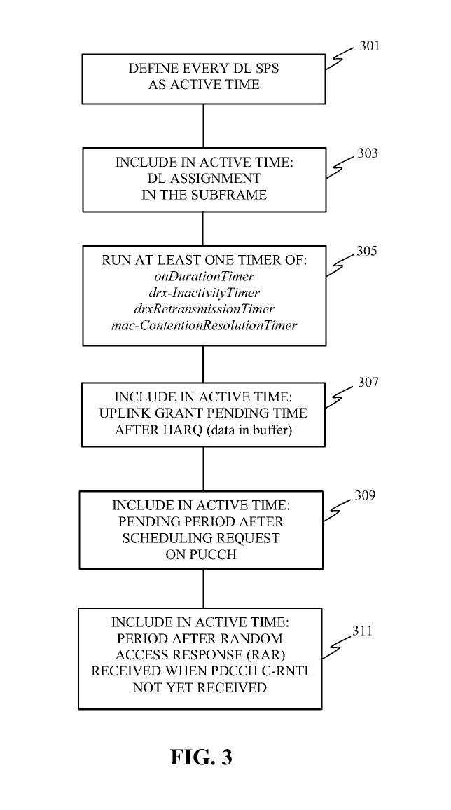

Referring to FIG. 3 this first process approach to a solution for UE active time in a DRX cycle is illustrated. The principle function is to define 301 every DL SPS as Active Time and include in Active Time 303 a downlink assignment configured in the subframe. During Active Time at least one of onDurationTimer, drx-InactivityTimer, drxRetransmissionTimer, and mac-ContentionResolutionTimer is running 305. The time period in which an uplink grant 307 is pending after HARQ with data in the HARQ buffer is defined as within Active Time. Also included in Active Time is the pendency period 309 after a Scheduling Request is sent on PUCCH. Finally, also to be included in Active Time is the period 311 after reception of a Random Access Response for the preamble not selected by UE during which a PDCCH signal indicating a new transmission is addressed to C-RNTI of UE is not yet received.

In a second potential solution, UE starts the HARQ RTT timer whenever there is new transmission, regardless it is in active time or not, regardless whether it is DS or SPS. Adoption of this solution would result in alteration of the specified requirements into the following form.
if the PDCCH indicates a DL transmission or if a DL assignment has been configured for this subframe:
   start the HARQ RTT Timer for the corresponding HARQ process;
   stop the drx-RetransmissionTimer for the corresponding HARQ process.
during the Active Time, for a PDCCH-subframe, if the subframe is not required for uplink transmission for half-duplex FDD UE operation and if the subframe is not part of a configured measurement gap:
   monitor the PDCCH;
if the PDCCH indicates a new transmission (DL or UL):
   start or restart drx-InactivityTimer;

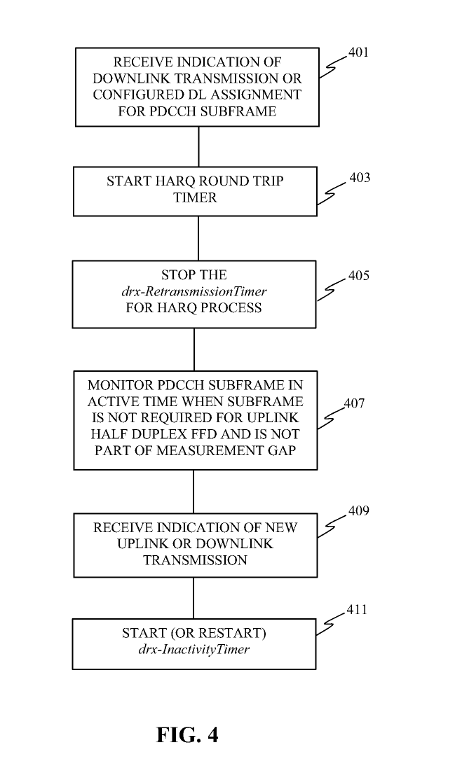

Referring to FIG. 4, this second process solution is illustrated. If PDCCH indicates a downlink transmission 401 or if a DL assignment has been configured for the PDCCH subframe, the HARQ round trip timer is started 403. Then the HARQ process drx-RetransmissionTimer is stopped 405. PDCCH is monitored 407 during Active Time when the subframe is not required for uplink half-duplex FDD UE operation and subframe is not part of a measurement gap. Finally, upon reception 409 of a new uplink or downlink transmission the drx-InactivityTimer is started or restarted 411.

As described above, FIGS. 3-4 are flowcharts of a method, apparatus and program product according to example embodiments of the two potential forms of invention. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device 24 of an apparatus 20 employing an embodiment of the present invention and executed by a processor 22 in the apparatus. As will be appreciated, any such computer program instructions may be loaded onto a computer or other programmable apparatus (e.g., hardware) to produce a machine, such that the resulting computer or other programmable apparatus embody a mechanism for implementing the functions specified in the flowchart blocks. These computer program instructions may also be stored in a non-transitory computer-readable storage memory (as opposed to a transmission medium such as a carrier wave or electromagnetic signal) that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s). As such, the operations of FIGS. 3-4, when executed, convert a computer or processing circuitry into a particular machine configured to perform an example embodiment of the present invention. Accordingly, the operations of FIGS. 3-4 define an algorithm for configuring a computer or processing circuitry (e.g., processor) to perform an example embodiment. In some cases, a general purpose computer may be configured to perform the functions shown in FIGS. 3-4 (e.g., via configuration of the processor), thereby transforming the general purpose computer into a particular machine configured to perform an example embodiment.

Accordingly, blocks of the flowcharts support combinations of means for performing the specified functions, combinations of operations for performing the specified functions and program instructions for performing the specified functions. It will also be understood that one or more blocks of the flowcharts, and combinations of blocks in the flowcharts, can be implemented by special purpose hardware-based computer systems which perform the specified functions or operations, or combinations of special purpose hardware and computer instructions. The means of implementing the described functions include means, such as a mobile terminal 20 having a processor 22 and a memory 24 in communication with the processor 22, the memory containing stored computer coded instructions that cause the mobile terminal apparatus 20 to perform the functions of the methods described above.

There are important benefits that may be realized from adoption of one or the other of the embodiments described herein. The first embodiment provides more scheduling opportunity for eNB and UE compared to the current LTE system. It will not cause additional power consumption because UE needs to be awake to decode new DL SPS transmissions. The second embodiment enables UE to start HARQ RTT for a DL SPS new transmission that occurs outside the active time. Therefore, UE could monitor a corresponding potential DL retransmission.

The following list of abbreviations and/or acronyms is provided as a reference for terms appearing in this description that may also appear in the claims to follow.
C-RNTI Cell Radio Network Temporary Identity
DL DownLink
DRX Discontinue Reception
DS Dynamic Scheduling
eNB Evolved Node B
HARQ Hybrid Automatic Repeat request
LTE Long Term Evolution
MAC Medium Access Control
PDCCH Physical Downlink Control Channel
PUCCH Physical Uplink Control Channel
RTT Round Trip Time
SFN Subframe Number
SPS Semi-Persistent Scheduling
UE User Equipment
UL UpLink

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1-5. (canceled)

6. A method comprising:
receiving an indication of a downlink transmission or a configured downlink assignment configured for the current PDCCH subframe;
starting a Hybrid Automatic Repeat request (HARQ) Round Trip Timer (RTT) whether UE is in active time or not; and
stopping a drx-Retransmission Timer for the corresponding HARQ process whether UE is in active time or not.

7. The method of claim 6, further comprising:
monitoring a Physical Downlink Control Channel (PDCCH) subframe when during active time the PDCCH subframe is not required for uplink transmission for half-duplex frequency division duplex (FFD) operation and is not part of a configured measurement gap;
receiving an indication of a new transmission, whether uplink or downlink; and
starting or restarting drx-InactivityTimer.

8-12. (canceled)

13. An apparatus comprising at least a processor, a memory in communication with said processor and having computer coded instructions stored therein, said instructions when executed by the processor configured to cause the apparatus to perform:
receiving an indication of a downlink transmission or a configured downlink assignment configured for the current PDCCH subframe;
starting a Hybrid Automatic Repeat request (HARQ) Round Trip Timer (RTT) whether UE is in active time or not; and
stopping a drx-Retransmission Timer for the corresponding HARQ process whether UE is in active time or not.

14. The apparatus of claim 13, further comprising instructions configured to cause the apparatus to perform:
monitoring a Physical Downlink Control Channel (PDCCH) subframe when during active time the PDCCH subframe is not required for uplink transmission for half-duplex frequency division duplex (FFD) operation and is not part of a configured measurement gap;
receiving an indication of a new transmission, whether uplink or downlink; and
starting or restarting drx-InactivityTimer.

15-19. (canceled)

20. A computer program product comprising a computer readable storage medium having computer coded instructions stored therein, said instructions when executed by the processor being configured to cause the apparatus to perform:
receiving an indication of a downlink transmission or a configured downlink assignment configured for the current PDCCH subframe;
starting a Hybrid Automatic Repeat request (HARQ) Round Trip Timer (RTT) whether UE is in active time or not; and
stopping a drx-RetransmissionTimer for the corresponding HARQ process whether UE is in active time or not.

21. The computer program product of claim 20, further comprising instructions configured to cause the apparatus to perform:
monitoring a Physical Downlink Control Channel (PDCCH) subframe when during active time the PDCCH subframe is not required for uplink transmission for half-duplex frequency division duplex (FFD) operation and is not part of a configured measurement gap;
receiving an indication of a new transmission, whether uplink or downlink; and
starting or restarting drx-InactivityTimer.

22-28. (canceled)
